(19) United States
(12) Patent Application Publication
(10) Pub. No.: US 2025/0249850 A1
(43) Pub. Date: Aug. 7, 2025

(54) CONTROL BOARD, CONTROL SYSTEM, CONTROL METHOD, AND COMPUTER PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Tomoya KONO, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/856,936

(22) PCT Filed: Apr. 3, 2023
(86) PCT No.: PCT/JP2023/013779

§ 371 Date: Oct. 15, 2024

(30) Foreign Application Priority Data
Apr. 21, 2022 (JP) 2022-070081

(51) Int. Cl. B60R 16/023; G06F 15/78

(52) U.S. Cl. CPC B60R 16/023; G06F 15/7882

(57) ABSTRACT

Disclosed is a control board configured to be mounted in a vehicle and capable of rewriting a circuit configuration, the control board including: a connector to which is connected a second end of a cable having a first end connected to a component mounted in the vehicle, the second end being located opposite to the first end; and a control unit configured to perform control of the component, wherein the control unit is configured to obtain, based on component information transmitted from the component via the cable, wiring data relating to an arrangement of a plurality of pins included in the connector, and a control program for controlling the component.

### CROSS-REFERENCE TO RELATED APPLICATIONS

This application is the U.S. national stage of PCT/JP2023/013779 filed on Apr. 3, 2023, which claims priority of Japanese Patent Application No. JP 2022-070081 filed on Apr. 21, 2022, the contents of which are incorporated herein.

### TECHNICAL FIELD

The present disclosure relates to a control board, a control system, a control method, and a computer program.

### BACKGROUND

Control boards configured to control components (e.g., sensors or actuators) mounted in vehicles are known. For example, JP 2021-132336A discloses an electronic control unit (ECU) configured to generate and output a control signal to a vehicle-mounted device such as a light sensor.

Conventionally, in order to control a component by a control board, it is necessary to incorporate, in the control board in advance, a control program for controlling the component. It is also necessary to use, as a cable for connecting the component and the control board to each other, a dedicated cable that has been adjusted for the component.

As such, it is necessary to prepare a control board and a cable for each component. Since a wide range of components are mounted in a vehicle, the numbers of control boards and cables increase with an increase in the number of components, resulting in an increase in the costs of management and the like.

In view of such a problem, an object of the present disclosure is to provide a control board, a control system, a control method, and a computer program that can be more universally used for components mounted in a vehicle.

### SUMMARY

A control board according to the present disclosure is a control board configured to be mounted in a vehicle and capable of rewriting a circuit configuration, the control board including: a connector to which is connected a second end of a cable having a first end connected to a component mounted in the vehicle, the second end being located opposite to the first end; and a control unit configured to perform control of the component, wherein the control unit is configured to obtain, based on component information transmitted from the component via the cable, wiring data relating to an arrangement of a plurality of pins included in the connector, and a control program for controlling the component.

A control method according to the present disclosure is a control method of a control board configured to be mounted in a vehicle and capable of rewriting a circuit configuration, the method including the steps of receiving, when a component mounted in the vehicle and the control board are connected to each other using a cable, component information transmitted to the control board from the component via the cable; and obtaining, based on the component information, wiring data relating to an arrangement of a plurality of pins that are included in the control board and are connected to the cable, and a control program for controlling the component.

A computer program according to the present disclosure is a computer program for controlling a control board configured to be mounted in a vehicle and capable of rewriting a circuit configuration, the computer program causing the control board to perform the steps of receiving, when a component mounted in the vehicle and the control board are connected to each other using a cable, component information transmitted to the control board from the component via the cable; and obtaining, based on the component information, wiring data relating to an arrangement of a plurality of pins that are included in the control board and are connected to the cable, and a control program for controlling the component.

### Advantageous Effects

According to the present disclosure, a control board can be more universally used for components mounted in a vehicle.

### BRIEF DESCRIPTION OF DRAWINGS

FIG. 1 is a diagram showing an example of a control system according to an embodiment.

FIG. 2 is a diagram schematically showing an arrangement of a plurality of pins according to an embodiment.

FIG. 3 is a flowchart illustrating an example of a control method according to an embodiment.

FIG. 4 is a subroutine illustrating the details of capacity determination processing shown in FIG. 3.

FIG. 5 is a flowchart illustrating an example of a control method according to an embodiment.

### DETAILED DESCRIPTION OF PREFERRED EMBODIMENTS

As an overview, embodiments of the present disclosure include the following configurations.

In a first aspect, a control board according to the present disclosure is a control board configured to be mounted in a vehicle and capable of rewriting a circuit configuration, the control board including: a connector to which is connected a second end of a cable having a first end connected to a component mounted in the vehicle, the second end being located opposite to the first end; and a control unit configured to perform control of the component, wherein the control unit is configured to obtain, based on component information transmitted from the component via the cable, wiring data relating to an arrangement of a plurality of pins included in the connector, and a control program for controlling the component.

With this configuration, the control board obtains the control program based on the component information provided from the component after the component is connected, instead of storing the control program in advance. Thus, the control board can be universally used according to the component.

In a second aspect, in the control board according to the first aspect, the component information may include the control program and the wiring data.

This configuration enables the control board to directly obtain the control program and the wiring data from the component information.

In a third aspect, in the control board according to the first aspect, the component information may include identification information for identifying the component. In this case, the control unit may be configured to: transmit, via a network, the component information to an external device installed outside the vehicle; and obtain, based on the identification information, the control program transmitted from the external device.

Since the control unit obtains the control program from the external device based on the identification information, the component information may include the identification information that requires less capacity than the control program. Accordingly, it is possible to reduce the capacity required for the storage unit of the component.

In a fourth aspect, in the control board according to the third aspect, the control unit may be configured to obtain, based on the identification information, the wiring data transmitted from the external device.

With this configuration, the component information need not include the control program and the wiring data. Accordingly, it is possible to further reduce the capacity required for the storage unit of the component.

In a fifth aspect, in the control board according to any one of the first through the fourth aspects, the control unit may be configured to rewrite, based on the wiring data, the arrangement of the plurality of pins to an arrangement for controlling the component, and thereafter perform control of the component based on the control program.

With this configuration, the component can be made controllable even in the case of using a universal cable as the cable. Accordingly, there is no need to prepare a cable for each type of component, and the number of cables is reduced, thus making it possible to reduce the cost of management and the like.

In a sixth aspect, in the control board according to the fifth aspect, the control unit may be configured to, when the first end is removed from the component, or when the second end is removed from the connector, return the arrangement of the plurality of pins to a state that existed prior to execution of the rewriting based on the wiring data.

This makes it possible to free up capacity of the storage unit included in the control board. Accordingly, when another component is connected subsequently, it is possible to secure a capacity for storing, in the storage unit, the component information transmitted from the other component.

In a seventh aspect, in the control board according to the fifth or the sixth aspects, the control unit may be configured to, when the first end is removed from the component, or when the second end is removed from the connector, delete the control program from the control board.

This makes it possible to free up capacity of the storage unit included in the control board. Accordingly, when another component is connected subsequently, it is possible to secure a capacity for storing, in the storage unit, the component information transmitted from the other component.

In an eighth aspect, a control system according to the present disclosure is a control system including: the control board according to any one of the first through the seventh aspects; the cable; and the component.

In a ninth aspect, a control method according to the present disclosure is a control method of a control board configured to be mounted in a vehicle and capable of rewriting a circuit configuration, the method including the steps of receiving, when a component mounted in the vehicle and the control board are connected to each other using a cable, component information transmitted to the control board from the component via the cable; and obtaining, based on the component information, wiring data relating to an arrangement of a plurality of pins that are included in the control board and are connected to the cable, and a control program for controlling the component.

With this configuration, the control board obtains the control program based on the component information provided from the component after the component is connected, instead of storing the control program in advance. Thus, the control board can be universally used according to the component.

In a tenth aspect, a computer program according to the present disclosure is a computer program for controlling a control board configured to be mounted in a vehicle and capable of rewriting a circuit configuration, the computer program causing the control board to perform the steps of receiving, when a component mounted in the vehicle and the control board are connected to each other using a cable, component information transmitted to the control board from the component via the cable; and obtaining, based on the component information, wiring data relating to an arrangement of a plurality of pins that are included in the control board and are connected to the cable, and a control program for controlling the component.

With this configuration, the control board obtains the control program based on the component information provided from the component after the component is connected, instead of storing the control program in advance. Thus, the control board can be universally used according to the component.

Hereinafter, details of embodiments of the present disclosure will be described with reference to the drawings.

### Configuration of Control System

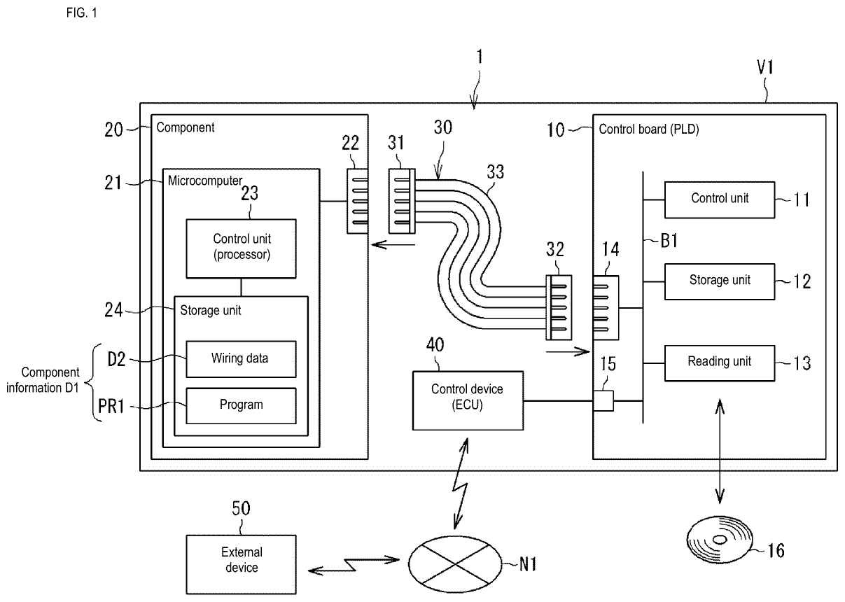

FIG. 1 is a diagram showing an exemplary configuration of a control system 1 according to an embodiment.

The control system 1 is a system mounted in a vehicle V1 such as an automobile. The control system 1 includes a control board 10, a component 20, a cable 30, and a control device 40. Each of these various portions 10, 20, 30, and 40 is mounted in the vehicle V1.

The control board 10 is a board capable of rewriting (reconfiguring) an internal circuit configuration thereof. The control board 10 is, for example, a programmable logic device (PLD). Among PLDs, the control board 10 may be a complex PLD (CPLD), or may be a field Programmable gate Array (FPGA).

The control board 10 is connected to the component 20 via the cable 30. The control board 10 performs control of the component 20 based on a control program PR1 described below. Specifically, the control board 10 includes a control unit 11, a storage unit 12, a reading unit 13, a connector 14, and a port 15. These various portions 11, 12, 13, 14, and 15 are each electrically connected by a bus B1, and are capable of transmitting/receiving a signal to and from each other.

The control unit 11 includes, for example, a circuit configuration (circuitry) such as a processor. Specifically, the control unit 11 includes one or more central processing units (CPUs). The processor included in the control unit 11 may be a graphics processing unit (GPU). In addition, the control unit 11 includes a programmable circuit capable of rewriting an internal circuit configuration thereof. The control unit 11 performs various calculations and controls by reading out a computer program stored in the storage unit 12.

The storage unit 12 includes a volatile memory and a nonvolatile memory, and stores various types of data. The volatile memory includes, for example, a random access memory (RAM). The nonvolatile memory includes, for example, a flash memory, a hard disk drive (HDD), a solid state drive (SSD), or a read only memory (ROM). The storage unit 12 stores, for example, a computer program and various parameters in the nonvolatile memory.

The reading unit 13 reads information from a computer-readable recording medium 16. The recording medium 16 is, for example, an optical disk such as a CD and a DVD, or a USB flash memory. The reading unit 13 is, for example, an optical drive or a USB terminal. A computer program and various parameters are recorded in the recording medium 16, and the computer program and the various parameters are stored in the nonvolatile memory of the storage unit 12 by the reading unit 13 reading the recording medium 16.

The connector 14 is connected to the cable 30. More specifically, the cable 30 includes a first end 31 connected to a connector 22 of the component 20, a second end 32 located opposite to the first end 31, and a wiring 33 that connects the first end 31 and the second end 32 to each other. The second end 32 of the cable 30 is connected to the connector 14.

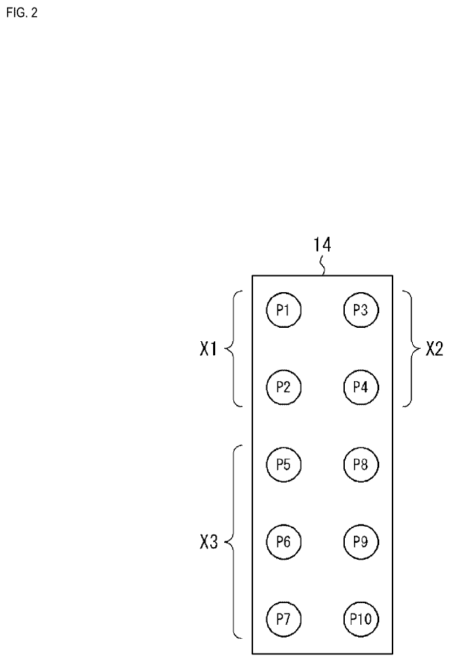

FIG. 2 is a diagram schematically showing an arrangement (pin assignment) of a plurality of pins included in the connector 14. In the example of FIG. 2, the connector 14 includes 10 pins. However, there is no particular limitation on the number of pins. The plurality of pins are grouped by function. The following describes a first pin group X1, a second pin group X2, and a third pin group X3 as an example of grouping. However, the plurality of pins may have groups other than the groups X1 to X3. In addition, the numbers of pins respectively included in the groups X1 to X3 are illustrative, and other numbers of pins may be included.

For example, two pins P1 and P2 belong to the first pin group X1. The first pin group X1 is a dedicated pin group for performing basic communication between the control board 10 and the component 20. The first pin group X1 is universally used regardless of the type of component 20. Accordingly, in a control method described below, the pin arrangement in the first pin group X1 remains unchanged.

For example, two pins P3 and P4 belong to the second pin group X2. The second pin group X2 is an initial communication pin group used when performing the first communication (initial communication) between the control board 10 and the component 20. The second pin group X2 is universally used regardless of the type of component 20. Accordingly, in a control method described below, the pin arrangement in the second pin group X2 remains unchanged.

For example, six pins P5, P6, P7, P8, P9, and P10 belong to the third pin group X3. The third pin group X3 is a control pin group used for controlling the component 20. The third pin group X3 is in a universal arrangement in the initial state, and the component 20 cannot be controlled in this state. Accordingly, the control unit 11 changes the circuit configuration based on wiring data D2 described below, thus rewriting the arrangement of the plurality of pins P5, P6, P7, P8, P9, and P10 included in the third pin group X3 to an arrangement for controlling the component 20.

Reference is made to FIG. 1. The port 15 is connected to the control device 40 via a communication line. The control device 40 is, for example, an electronic control unit (ECU) that assists the operation of the control board 10. The control device 40 includes a control unit, a storage unit, and a communication unit (not shown).

Similarly to the control unit 11, the control unit of the control device 40 includes a circuit configuration such as a processor. Similarly to the storage unit 12, the storage unit of the control device 40 includes a volatile memory and a nonvolatile memory, and stores various types of data.

The communication unit of the control device 40 is an interface for wirelessly communicate with the external device 50 via a network N1 (a network outside the vehicle V1) such as the Internet. The communication unit is, for example, a telematics communication unit (TCU).

The external device 50 is a device installed outside the vehicle V1. The external device 50 is, for example, a server including a control unit, a storage unit, and a communication unit. The storage unit of the external device 50 stores, for example, a program or data for controlling the various portions (e.g., the control board 10 and the component 20) of the control system 1.

For example, the manufacturer of the component 20 modifies a control program PR1 for controlling the component 20 as needed, and stores the modified control program PR1 in the storage unit of the external device 50 when desired. At this time, identification information D3 (e.g., the serial number of the component 20) for identifying the component 20 and the control program PR1 of the component 20 are stored in association with each other. The communication unit of the external device 50 transmits the modified control program PR1 to the control device 40 in response to a request from the control device 40. The external device 50 is also referred to as an over the air (OTA) server.

The component 20 is, for example, a sensor for detecting the state of the vehicle V1. In this case, the component 20 may be a luminance sensor, or may be a temperature sensor. In this case, the component 20 transmits the detected state of the vehicle V1 in the form of a detection signal to the control board 10 via the cable 30.

The component 20 may be an actuator for driving various portions of the vehicle V1. In this case, the component 20 may be an opening/closing driving portion that opens/closes a sunroof or a door, or may be a seat heater that heats a seat. In this case, the component 20 performs driving based on a control signal transmitted from the control board 10 via the cable 30.

The component 20 may be a set of a sensor and an actuator. For example, the component 20 is a set of a luminance sensor and an opening/closing driving portion that opens/closes a sunroof. In this case, the luminance sensor included in the component 20 transmits a detection signal to the control board 10 via the cable 30, and the control board 10 generates a control signal based on the detection signal and transmits the control signal to the component 20 via the cable 30. Then, the opening/closing driving portion included in the component 20 opens/closes the sunroof based on the control signal. This configuration allows the sunroof to be opened/closed according to the luminance.

Note that the component 20 may be a set of a temperature sensor and a seat heater. In this case, the temperature sensor included in the component 20 transmits a detection signal to the control board 10 via the cable 30, and the control board 10 generates a control signal based on the detection signal and transmits the control signal to the component 20 via the cable 30. Then, the seat heater included in the component 20 heats a seat based on the control signal. This configuration allows the seat to be heated according to the temperature.

The component 20 may be mounted in the vehicle V1 at the time of shipment of the vehicle V1. That is, the component 20 may be a component already existing in the vehicle V1. The component 20 may be added to the vehicle V1 after shipment of the vehicle V1. For example, the user of the vehicle V1 may himself/herself (or entrust a dealer or the like to) add the component 20 after the delivery of the vehicle V1. That is, the component 20 may be a component retrofitted to the vehicle V1.

The component 20 includes a microcontroller unit 21 (hereinafter referred to as a “microcomputer 21”) and a connector 22. The connector 22 is connected to the first end 31 of the cable 30. The microcomputer 21 includes a control unit 23 and a storage unit 24.

The control unit 23 includes, for example, a circuit configuration such as a processor. Specifically, the control unit 23 includes one or more CPUs. The processor included in the control unit 23 may be a GPU. The control unit 23 performs various calculations and controls by reading out a computer program stored in the storage unit 24.

The storage unit 24 includes a volatile memory and a nonvolatile memory, and stores various types of data. The volatile memory includes, for example, a RAM. The nonvolatile memory includes, for example, a flash memory or a ROM. The storage unit 24 stores, in the nonvolatile memory, a computer program, component information D1 relating to the component 20, and other various types of data.

The component information D1 includes, for example, a control program PR1 and wiring data D2. The control program PR1 is a program for controlling the component 20. The wiring data D2 is data relating to the arrangement of the plurality of pins included in the connector 14. More specifically, the wiring data D2 is data for rewriting the arrangement of the pins P5, P6, P7, P8, P9, and P10 included in the third pin group X3 to an arrangement suitable for controlling the component 20, and includes, for example, designation of the pin assignment in the third pin group X3.

The cable 30 is a vehicle harness cable formed by a bundle of a plurality of communication lines. The cable 30 is not a dedicated line adjusted for the component 20, but is a universal cable in which the plurality of communication lines function as universal lines.

Of the plurality of communication lines included in the cable 30, a communication line that is connected to the pins P1 and P2 (the first pin group X1) of the connector 14 functions as a communication line group (first communication line group) for performing basic communication between the control board 10 and the component 20.

Of the plurality of communication lines included in the cable 30, a communication line that is connected to the pins P3 and P4 (second pin group X2) of the connector 14 functions as a communication line group (second communication line group) for initial communication between the control board 10 and the component 20.

Of the plurality of communication lines included in the cable 30, a communication line that is connected to the pins P5, P6, P7, P8, P9, and P10 (third pin group X3) of the connector 14 functions as a control communication line group (third communication line group) used for controlling the component 20.

### Problem that the Present Embodiment is to Solve

In order to control the component 20 using the control board 10, the control program PR1 for controlling the component 20 needs to be installed in the control board 10. In addition, a cable having a pin assignment corresponding to the component 20 needs to be used as the cable 30 that connects the control board 10 and the component 20 to each other.

Conventionally, in order to control the component 20, the control program PR1 is installed in advance (i.e., before connecting the component 20 to the control board 10 via the cable 30) in the control board 10. Also, conventionally, a cable (dedicated cable) having a pin assignment corresponding to the component 20 is prepared in advance as the cable 30.

Accordingly, it is necessary to prepare a control board 10 and a cable 30 for each type of component 20. Also, since a wide range of components 20 are mounted in the vehicle V1, the numbers of control boards 10 and cables 30 are increased by a number equal to the number of components 20, resulting in an increase in the costs of management and the like.

In addition, there is a need to retrofit the component 20 after shipment of the vehicle V1. Conventionally, in order to retrofit a component 20, a control board 10 and a cable 30 corresponding to the component 20 need to be prepared, in addition to the component 20. Accordingly, it may not be possible to meet the need to retrofit the component 20, for example, due to a large amount of cost and a large space required to retrofit the component 20.

Furthermore, there is also a need to replace the component 20 for the control board 10. For example, it may be desirable to replace an actuator that drives a sunroof to open/close by a set of a luminance sensor and an actuator. Conventionally, it is not possible to control the component 20 by replacing only the component 20 while leaving the control board 10 and the cable 30 as they are.

Therefore, in the control system 1 according to the present embodiment, the component information D1 is stored in advance in the storage unit 24 of the component 20, and the component information D1 is transmitted to the control board 10 from the component 20 when connecting the component 20 to the control board 10 using the cable 30. Then, the control board 10 obtains the wiring data D2 and the control program PR1 based on the component information D1. The control board 10 rewrites, based on the wiring data D2, the pin assignment of the connector 14 to an arrangement suitable for controlling the component 20, and thereafter performs control of the component 20 based on the control program PR1.

In this manner, the control board 10 obtains the control program PR1 based on the component information D1 provided from the component 20 after the component 20 is connected, instead of storing the control program PR1 in advance. Thus, the control board 10 can be universally used according to the component 20. As a result, there is no need to prepare a control board 10 for each type of component 20, and the number of control boards 10 is reduced, thus making it possible to reduce the cost of management and the like.

Furthermore, in order to obtain the control program PR1 after the component 20 is connected, the control board 10 can be adapted to retrofit or replace the component 20. Accordingly, it is possible to more flexibly meet user needs that have been conventionally difficult to be met.

Since the control board 10 rewrites, based on the wiring data D2, the pin assignment of the connector 14 to an arrangement suitable for controlling the component 20, it is possible to use a universal cable as the cable 30. Accordingly, there is no need to prepare a cable 30 for each type of component 20, and the number of cables 30 is reduced, thus making it possible to further reduce the cost of management and the like.

A control method used in the control system 1 will be specifically described below.

### Control Method

Control Performed when Connecting Component

A control performed by the control board 10 when the component 20 is connected to the control board 10 will be described.

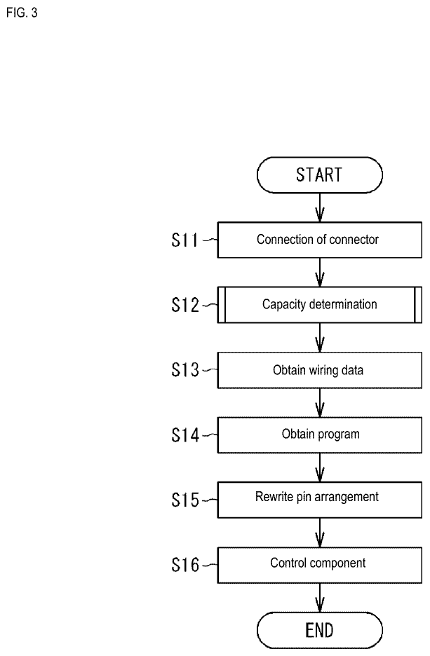

FIG. 3 is a flowchart illustrating an example of a control method performed by the control system 1. FIG. 3 shows control performed by the control board 10. The control performed by the control board 10 is realized by the control unit 11 performing various calculations and processing by reading a computer program from the storage unit 12 (or in accordance with a program written in advance in the control unit 11). The order of the steps shown in FIG. 3 may be changed as necessary. For example, the order of step S13 and step S14 described below may be reversed.

First, the control unit 11 detects that the component 20 has been connected to the control board 10 via the cable 30 (step S11). Specifically, when the first end 31 of the cable 30 is connected to the connector 22 of the component 20, and the second end 32 of the cable 30 is connected to the connector 14 of the control board 10, connection information indicating completion of connection is transmitted from the component 20 to the control board 10 via the cable 30. The connection information is input to the first pin group X1 of the connector 14 via the first communication line group of the cable 30, for example. The connection information is continuously input to the first pin group X1 while the component 20 is being connected. Based on the input connection information, the control unit 11 detects that the component 20 has been connected.

The input of the connection information is commonly performed regardless of the type of component 20. Accordingly, the first pin group X1 of the connector 14 need not be adjusted for each component 20, and can be used universally.

Next, the component information D1 is transmitted from the component 20 to the control board 10 via the cable 30. The control unit 11 determines whether a capacity sufficient to store the component information D1 is present in the storage unit 12 (capacity determination processing: step S12).

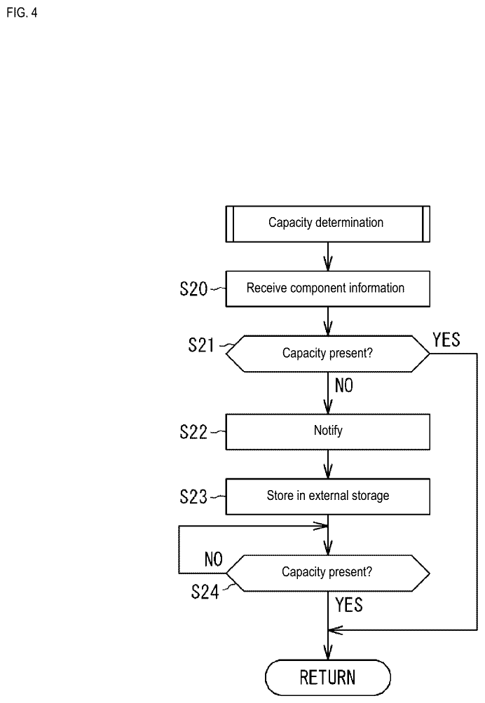

FIG. 4 is a subroutine illustrating the details of the capacity determination processing. The order of the steps shown in FIG. 4 may be changed as necessary. For example, the order of step S22 and step S23 described below may be reversed. Also, each of the steps shown in FIG. 4 may be omitted as necessary. For example, step S21 to step S24 described below may be omitted, and only step S20 described below may be performed.

First, the control board 10 receives the component information D1 (initial communication: step S20). The component information D1 is transmitted from the component 20, and is input to the second pin group X2 of the connector 14 via the second communication line group of the cable 30.

The input of the component information D1 is commonly performed regardless of the type of component 20. Accordingly, the second pin group X2 of the connector 14 need not be adjusted for each component 20, and can be universally used.

Next, the control unit 11 determines whether a capacity sufficient to store the component information D1 is present in the storage unit 12 (step S21). If the capacity is present (YES in step S21), the control unit 11 proceeds to the processing in step S13.

If the capacity is not present (NO in step S21), the control unit 11 notifies the user of shortage of capacity (step S22). For example, the control unit 11 provides, on a display unit (e.g., a display), which is not shown, connected to the control board 10, display indicating that “CAPACITY IS INSUFFICIENT” or the like. In this case, a countermeasure such as “REFRESH MEMORY?” and options, such as “YES” and “NO”, to ask whether to perform the countermeasure may be further displayed on the display unit. For example, when the user selects “YES” displayed on the display unit using an input unit (e.g., a button), which is not shown, connected to the control board 10, the control unit 11 refreshes the storage unit 12. For example, the control unit 11 deletes, from the storage unit 12, a control program or the like for controlling a component that is currently not connected.

Thereafter, the control unit 11 temporarily stores the component information D1 in a storage device (external storage) outside the control board 10 (step S23). The external storage is, for example, the storage unit of the control device 40. In this case, the control unit 11 transmits the component information D1 to the control device 40 via the port 15, and stores the component information D1 in the storage unit of the control device 40. Note that a separate device may be prepared as the external storage.

Next, after a predetermined time has elapsed after step S23, the control unit 11 again determines whether a capacity sufficient to store the component information D1 is present in the storage unit 12 (step S24). If the capacity is not present (NO in step S24), the control unit 11 repeats step S24. If the capacity is present (YES in step S24), the control unit 11 proceeds to the processing in step S13.

Reference is made to FIG. 3. The control unit 11 stores the component information D1 in the storage unit 12. The component information D1 includes the wiring data D2 and the control program PR1. Accordingly, by storing the component information D1 in the storage unit 12, the control unit 11 obtains the wiring data D2 (step S13), and obtains the control program PR1 (step S14). That is, the control unit 11 installs the control program PR1 based on the component information D1.

Next, based on the wiring data D2, the control unit 11 rewrites the arrangement of the plurality of pins P5, P6, P7, P8, P9, and P10 included in the third pin group X3 to an arrangement for controlling the component 20 (rewriting processing: step S15). Thus, the component 20 can be made controllable even in the case of using a universal cable as the cable 30. Accordingly, there is no need to prepare a cable 30 for each type of component 20, and the number of cables 30 is reduced, thus making it possible to reduce the cost of management and the like.

Thereafter, the control unit 11 performs control of the component 20 based on the control program PR1 (step S16). In this manner, the control board 10 obtains the control program PR1 based on the component information D1 provided from the component 20 after the component 20 is connected, instead of storing the control program PR1 in advance. Thus, the control board 10 can be universally used according to the component 20. As a result, there is no need to prepare a control board 10 for each type of component 20, and the number of control boards 10 is reduced, thus making it possible to reduce the cost of management and the like.

Control Performed when Removing Component

A control performed by the control board 10 when the component 20 is removed from the control board 10 will be described.

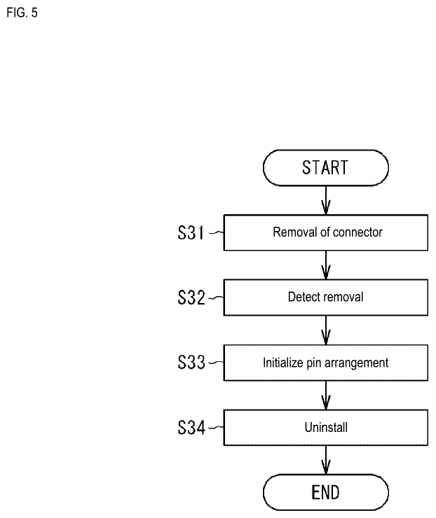

FIG. 5 is a flowchart illustrating an example of a control method performed by the control system 1. FIG. 5 shows control performed by the control board 10. The order of the steps shown in FIG. 5 may be changed as necessary. For example, the order of step S33 and step S34 described below may be reversed.

First, the component 20 is removed from the control board 10 (step S31). For example, the first end 31 of the cable 30 is removed from the connector 22 of the component 20. Note that the second end 32 of the cable 30 may be removed from the connector 14 of the control board 10. In either case, “the component 20 is removed from the control board 10”.

Next, the control unit 11 detects removal of the component 20 (step S32). Specifically, when the component 20 is removed from the control board 10, the connection information is no longer input to the control board 10 from the component 20. Based on the interruption of the connection information, the control unit 11 detects removal of the component 20.

After detecting removal of the component 20, the control unit 11 initializes the arrangement of the third pin group X3 (step S33). Specifically, the control unit 11 returns the arrangement of the plurality of pins P5, P6, P7, P8, P9, and P10 included in the third pin group X3 to a state that existed prior to execution of the rewriting processing in step S15 (FIG. 3). Consequently, the third pin group X3 is in a universal arrangement (initial state).

Next, the control unit 11 deletes (uninstalls) the control program PR1 stored in the storage unit 12 (step S34). Here, to “delete the control program PR1” means either to completely erase the control program PR1 from the storage unit 12, or to make a region of the storage unit 12 in which the control program PR1 is stored rewritable while leaving the presence of the control program PR1 in the storage unit 12. In either case, it is possible to free up capacity of the storage unit 12. Accordingly, when another component 20 is connected after removal of the component 20, it is possible to secure a capacity for storing, in the storage unit 12, the component information D1 transmitted from the other component 20.

In step S34, the control unit 11 may further delete the wiring data D2 stored in the storage unit 12. As in the case of the control program PR1, the control unit 11 may completely erase the wiring data D2 from the storage unit 12, or make a region of the storage unit 12 in which the wiring data D2 is stored rewritable while leaving the presence of the wiring data D2 in the storage unit 12. That is, in step S34, the control unit 11 may delete both the control program PR1 and the wiring data D2 (i.e., the component information D1). This makes it possible to free up more capacity of the storage unit 12. Accordingly, when another component 20 is connected subsequently, it is possible to more reliably secure a capacity for storing, in the storage unit 12, the component information D1 transmitted from the other component 20.

Note that in step S34, the control unit 11 may delete the wiring data D2 without deleting the control program PR1. With this configuration as well, it is possible to free up capacity of the storage unit 12.

### MODIFICATIONS

In the following, modifications of the embodiment will be described. In the modifications, the same constituent elements as those of the above-described embodiment are denoted by the same reference numerals, and descriptions thereof will be omitted.

### Modification 1 of Component Information

In the above embodiment, the component information D1 includes the wiring data D2 and the control program PR1, and the control unit 11 directly obtains the wiring data D2 and the control program PR1 via the component information D1 transmitted from the component 20. In contrast, component information D1 according to the present modification includes identification information D3 for identifying the component 20. The identification information D3 is, for example, the serial number of the component 20. In this case, the component information D1 need not include the wiring data D2 and the control program PR1.

Reference is made to FIGS. 1 and 3.

A control board 10 according to the present modification performs steps S11 and S12 as in the case of the embodiment. Thereafter, the control board 10 obtains the wiring data D2 and the control program PR1 from the external device 50 via the network N1 based on the identification information D3 (steps S13 and S14).

Specifically, the control unit 11 receives the component information D1 including the identification information D3 from the component 20, and thereafter transmits the identification information D3 to the control device 40 via the port 15. The control device 40 transmits the identification information D3 to the external device 50 via the network N1. In the external device 50, the wiring data D2 and the control program PR1 are stored in association with the identification information D3.

The external device 50 transmits, to the control device 40 via the network N1, the wiring data D2 and the control program PR1 corresponding to the received identification information D3. The control device 40 transmits the received wiring data D2 and control program PR1 to the control board 10. The control unit 11 stores the received wiring data D2 and control program PR1 in the storage unit 12. Thus, the control unit 11 obtains the wiring data D2 and the control program PR1.

In this case, the control unit 11 obtains the wiring data D2 and the control program PR1 from the external device 50 based on the identification information D3. Accordingly, the component information D1 need not include the wiring data D2 and the control program PR1, and the component information D1 may include the identification information D3 that requires less capacity than the total of the wiring data D2 and the control program PR1. Accordingly, it is possible to reduce the capacity required for the storage unit of the component 20.

The control program PR1 stored in the external device 50 is updated as needed. Accordingly, the control board 10 can obtain the latest control program PR1 (e.g., a control program PR1 resulting from modifying the initially released control program), thus allowing the component 20 to be more suitably controlled.

### Modification 2 of Component Information

In the above modification, the control unit 11 obtains both the wiring data D2 and the control program PR1 from the external device 50 based on the identification information D3. However, the control unit 11 may obtain the control program PR1 from the external device 50 based on the identification information D3, and obtain the wiring data D2 from the component information D1.

In this case, the component information D1 includes the wiring data D2 and the identification information D3. The control unit 11 extracts the wiring data D2 from the received component information D1, and stores the wiring data D2 in the storage unit 12. Thus, the control unit 11 obtains the wiring data D2. In addition, the control unit 11 extracts the identification information D3 from the component information D1, and transmits the identification information D3 to the external device 50 via the control device 40 and the network N1. Then, the control unit 11 obtains the control program PR1 by storing, in the storage unit 12, the control program PR1 transmitted from the external device 50.

In the case of the present modification, the component information D1 need not include the control program PR1. Since the control unit 11 obtains the control program PR1 from the external device 50 based on the identification information D3, the component information D1 may include, in place of the control program PR1, the identification information D3 that requires less capacity than the control program PR1. Accordingly, it is possible to reduce the capacity required for the storage unit of the component 20.

Note that the component information D1 may include the control program PR1 and the identification information D3. In this case, the control unit 11 obtains the control program PR1 included in the component information D1, and obtains the wiring data D2 from the external device 50 via the network N1 based on the identification information D3.

### Control Performed by Control Device

In the above-described embodiment, the control board 10 controls the component 20. However, for example, when the control of the component 20 is more complex, the calculations and processing performed by the control board 10 may be shared with the control device 40.

For example, when the component 20 is a set of an actuator that drives a sunroof to open/close, and a luminance sensor, the control device 40 may determine, based on a detection signal of the luminance sensor, whether opening/closing of the sunroof is to be performed, and thereafter instruct the control board 10 to be opened/closed, and the control board 10 may generate and output a control signal of the actuator based on that instruction. Alternatively, the control device 40 may generate a control signal of the actuator and transmit the control signal to the control board 10, and the control board 10 may directly relay the received control signal to the component 20.

With this configuration, the processing load on the control unit 11 can be further reduced.

In this case, for example, processing to be performed by the control board 10 and processing to be performed by the control device 40 are described in the control program PR1. The control unit 11 obtains the control program PR1 in step S14, thereafter copies the control program PR1 as it is, and transmits the control program PR1 to the control device 40, thus installing the control program PR1 also in the control device 40. Note that the control unit 11 may extract only a portion of the control program PR1 that corresponds to the processing to be performed by the control device 40, and transmit only that portion.

### SUPPLEMENT

Note that at least some of each of the embodiment and various modifications described above may be combined with each other. It should be appreciated the embodiment and modifications disclosed herein are to be construed in all respect illustrative and not limiting. The scope of the present disclosure is defined by the claims, and is intended to include all modifications which fall within the scope of the claims and the meaning and scope of equivalents thereof.

1. A control board configured to be mounted in a vehicle and capable of rewriting a circuit configuration, the control board comprising:
a connector to which is connected a second end of a cable having a first end connected to a component mounted in the vehicle, the second end being located opposite to the first end; and
a control unit configured to perform control of the component, wherein
the control unit is configured to obtain, based on component information transmitted from the component via the cable, wiring data relating to an arrangement of a plurality of pins included in the connector, and a control program for controlling the component.

2. The control board according to claim 1, wherein the component information includes the control program and the wiring data.

3. The control board according to claim 1, wherein
the component information includes identification information for identifying the component, and
the control unit is configured to:
transmit, via a network, the component information to an external device installed outside the vehicle; and
obtain, based on the identification information, the control program transmitted from the external device.

4. The control board according to claim 3, wherein the control unit is configured to obtain, based on the identification information, the wiring data transmitted from the external device.

5. The control board according to claim 1, wherein the control unit is configured to rewrite, based on the wiring data, the arrangement of the plurality of pins to an arrangement for controlling the component, and thereafter perform control of the component based on the control program.

6. The control board according to claim 5, wherein the control unit is configured to, when the first end is removed from the component, or when the second end is removed from the connector, return the arrangement of the plurality of pins to a state that existed prior to execution of the rewriting based on the wiring data.

7. The control board according to claim 5, wherein the control unit is configured to, when the first end is removed from the component, or when the second end is removed from the connector, delete the control program from the control board.

8. A control system comprising:
the control board according to claim 1;
the cable; and
the component.

9. A control method of a control board configured to be mounted in a vehicle and capable of rewriting a circuit configuration, the method comprising the steps of:
receiving, when a component mounted in the vehicle and the control board are connected to each other using a cable, component information transmitted to the control board from the component via the cable; and
obtaining, based on the component information, wiring data relating to an arrangement of a plurality of pins that are included in the control board and are connected to the cable, and a control program for controlling the component.

10. (canceled)

11. The control board according to claim 2, wherein the control unit is configured to rewrite, based on the wiring data, the arrangement of the plurality of pins to an arrangement for controlling the component, and thereafter perform control of the component based on the control program.

12. The control board according to claim 3, wherein the control unit is configured to rewrite, based on the wiring data, the arrangement of the plurality of pins to an arrangement for controlling the component, and thereafter perform control of the component based on the control program.

13. The control board according to claim 4, wherein the control unit is configured to rewrite, based on the wiring data, the arrangement of the plurality of pins to an arrangement for controlling the component, and thereafter perform control of the component based on the control program.
